(19) United States
(12) Patent Application Publication
(10) Pub. No.: US 2026/0330417 A1
(43) Pub. Date: Oct. 22, 2026

(54) SYSTEMS, APPARATUSES, METHODS, AND COMPUTER PROGRAM PRODUCTS FOR AUTOMATED PROJECT QUALITY CONTROL

(71) Applicant: HONEYWELL INTERNATIONAL INC., Charlotte, NC (US)

(72) Inventors: Anil PALLAYIL, Charlotte, NC (US); Rahul SHARMA, Houston, TX (US); Honey RAGHAVAN, Bangalore (IN)

(21) Appl. No.: 19/651,034

(22) Filed: Apr. 17, 2026

Related U.S. Application Data
(60) Provisional application No. 63/790,892, filed on Apr. 18, 2025.

(51) Int. Cl. G06Q 10/10; G06F 3/048; G06Q 10/0631

(52) U.S. Cl. CPC G06Q 10/103; G06F 3/048; G06Q 10/06313

(57) ABSTRACT

Systems, apparatuses, methods, and computer program products are provided herein. For example, a method provided herein may include, accessing at least one dataset based on the at least one user input. In some embodiments, the method comprises generating at least one data object based on the at least one user input and the at least one dataset. In some embodiments, the method comprises generating at least one natural language output based on the at least one user input and the at least one data object. In some embodiments, the method comprises causing rendering of the at least one natural language output and at least one media element on the GUI. In some embodiments, the method comprises updating at least one profile associated with the project based at least in part on the at least one parameter and the at least a subset of the at least one data object.

### CROSS REFERENCE TO RELATED APPLICATIONS

This application claims the benefit of and priority to U.S. Application No. 63/790,892, filed Apr. 18^{th}, 2025, entitled “SYSTEMS, APPARATUSES, METHODS, AND COMPUTER PROGRAM PRODUCTS FOR AUTOMATED PROJECT QUALITY CONTROL,” the disclosure of which is incorporated herein by reference in its entirety.

### TECHNOLOGICAL FIELD

Embodiments of the present disclosure relate generally to systems, apparatuses, methods, and computer program products for automated project quality control.

### BACKGROUND

Applicant has identified many technical challenges and difficulties associated with systems, apparatuses, methods, and computer program products for automated project quality control. Through applied effort, ingenuity, and innovation, Applicant has solved problems related to systems, apparatuses, methods, and computer program products for automated project quality control by developing solutions embodied in the present disclosure, which are described in detail below.

### BRIEF SUMMARY

Various embodiments described herein relate to systems, apparatuses, methods, and computer program products for automated project quality control.

In accordance with one aspect of the disclosure a method is provided. In some embodiments, in response to receiving at least one user input to a graphical user interface (GUI) on a user device, the method comprises accessing, at a project orchestration predictive computing entity, at least one dataset based at least in part on the at least one user input. In some embodiments, the at least one user input comprises natural language indicating a request associated with at least one parameter of a project. In some embodiments, the method comprises generating, using a project record predictive computing entity, at least one data object based at least in part on the at least one user input and the at least one dataset. In some embodiments, the method comprises generating, using the project orchestration predictive computing entity, at least one natural language output based at least in part on the at least one user input and the at least one data object. In some embodiments, the method comprises causing rendering of the at least one natural language output and at least one media element on the GUI. In some embodiments, the at least one media element is representative of the at least one data object. In some embodiments, in response to receiving a second user input to the GUI comprising an approval of at least a subset of the at least one data object, the method comprises updating, using the project record predictive computing entity, at least one profile associated with the project based at least in part on the at least one parameter and the at least a subset of the at least one data object.

In some embodiments, the method comprises generating, using a project prompt predictive computing entity, at least one embedding representative of the at least one user input.

In some embodiments, the method comprises accessing, using the project orchestration predictive computing entity, the at least one dataset based at least in part on the at least one embedding.

In some embodiments, the at least one parameter of the project comprises a project design, the at least one data object comprises a project design electronic record, and the at least one media element comprises a representation of the project design electronic record.

In some embodiments, the at least one parameter of the project further comprises a project proposal, a first portion of the project proposal is associated with the project design, and a second portion of the project proposal is associated with a project resource impact value. In some embodiments, in response to receiving an approval of the project design electronic record, the method comprises generating, using the project record predictive computing entity and based at least in part on the at least one dataset, a resource impact value electronic record. In some embodiments, the method comprises generating, using the project orchestration predictive computing entity, a second natural language output and a second media element based at least in part on the resource impact value electronic record. In some embodiments, the method comprises causing rendering of the second natural language output and the second media element on the GUI.

In some embodiments, in response to receiving an approval of the resource impact value electronic record, the method comprises generating, using the project record predictive computing entity, a project proposal electronic record based at least in part on the resource impact value electronic record and the project design electronic record.

In some embodiments, the method comprises generating, using the project orchestration predictive computing entity, a third natural language output and a third media element based at least in part on the project proposal electronic record. In some embodiments, the method comprises causing rendering of the third natural language output and the third media element on the GUI. In some embodiments, in response to receiving an approval of the project proposal electronic record, the method comprises causing provision of the project proposal electronic record to a project foundation device.

In some embodiments, in response to receiving from the project foundation device an approval to perform the project in accordance with the project proposal electronic record, the method comprises causing provision of the project proposal electronic record to at least one of an external project application device or an external project implementation device.

In some embodiments, in response to receiving an authorization from the project foundation device, the method comprises causing, using a project command predictive computing entity, performance of at least one project action in accordance with the project proposal electronic record.

In some embodiments, the method comprises generating the at least one data object using at least one large language model (LLM).

In some embodiments, the method comprises generating the at least one natural language output using the at least one LLM.

In some embodiments, in response to receiving a user input comprising at least one modification to the at least one data object, the method comprises generating, using a project prompt predictive computing entity, at least one embedding representative of the at least one modification. In some embodiments, the method comprises modifying, using the project record predictive computing entity, the at least one data object based at least in part on the at least one embedding.

In some embodiments, the method comprises training, using the project record predictive computing entity, an instance of the at least one LLM based at least in part on at least one of the at least one modification, the at least one embedding, or the at least one data object.

In some embodiments, the method comprises obtaining, at the project orchestration predictive computing entity, at least one identifier associated with at least one of the user device or a user entity associated with the user device. In some embodiments, the method comprises storing, at a data store, the instance of the at least one LLM in association with the at least one identifier.

In accordance with one aspect of the disclosure an apparatus is provided. In some embodiments, the apparatus comprises memory and one or more processors communicatively coupled to the memory. In some embodiments, in response to receiving at least one user input to a graphical user interface (GUI) on a user device, the one or more processors are configured to perform operations comprising accessing, at a project orchestration predictive computing entity, at least one dataset based at least in part on the at least one user input. In some embodiments, the at least one user input comprises natural language indicating a request associated with at least one parameter of a project. In some embodiments, the one or more processors are configured to perform operations comprising generating, using a project record predictive computing entity, at least one data object based at least in part on the at least one user input and the at least one dataset. In some embodiments, the one or more processors are configured to perform operations comprising generating, using the project orchestration predictive computing entity, at least one natural language output based at least in part on the at least one user input and the at least one data object. In some embodiments, the one or more processors are configured to perform operations comprising causing rendering of the at least one natural language output and at least one media element on the GUI. In some embodiments, the at least one media element is representative of the at least one data object. In some embodiments, in response to receiving a second user input to the GUI comprising an approval of at least a subset of the at least one data object, the one or more processors are configured to perform operations comprising updating, using the project record predictive computing entity, at least one profile associated with the project based at least in part on the at least one parameter and the at least a subset of the at least one data object.

In accordance with one aspect of the disclosure a computer program product is provided. In some embodiments, the computer program product comprises at least one non-transitory computer-readable storage medium having computer program code stored thereon. In some embodiments, in response to receiving at least one user input to a graphical user interface (GUI) on a user device, the computer program code, in execution with at least one processor, configures the computer program product for accessing, at a project orchestration predictive computing entity, at least one dataset based at least in part on the at least one user input. In some embodiments, the at least one user input comprises natural language indicating a request associated with at least one parameter of a project. In some embodiments, the computer program code, in execution with at least one processor, configures the computer program product for generating, using a project record predictive computing entity, at least one data object based at least in part on the at least one user input and the at least one dataset. In some embodiments, the computer program code, in execution with at least one processor, configures the computer program product for generating, using the project orchestration predictive computing entity, at least one natural language output based at least in part on the at least one user input and the at least one data object. In some embodiments, the computer program code, in execution with at least one processor, configures the computer program product for causing rendering of the at least one natural language output and at least one media element on the GUI. In some embodiments, the at least one media element is representative of the at least one data object. In some embodiments, in response to receiving a second user input to the GUI comprising an approval of at least a subset of the at least one data object, the computer program code, in execution with at least one processor, configures the computer program product for updating, using the project record predictive computing entity, at least one profile associated with the project based at least in part on the at least one parameter and the at least a subset of the at least one data object.

### BRIEF DESCRIPTION OF THE DRAWINGS

Reference will now be made to the accompanying drawings. The components illustrated in the figures may or may not be present in certain embodiments described herein. Some embodiments may include fewer (or more) components than those shown in the figures in accordance with an example embodiment of the present disclosure.

FIG. 1 illustrates an example block diagram of an environment in which embodiments of the present disclosure may operate;

FIG. 2 illustrates an example block diagram of the environment in which embodiments of the present disclosure may operate;

FIG. 3 illustrates an example block diagram of an example apparatus that may be specially configured in accordance with an example embodiment of the present disclosure;

FIG. 4 illustrates an example graphical user interface (GUI) rendered on a display of a user device in accordance with one or more embodiments of the present disclosure;

FIG. 5 illustrates an example GUI rendered on a display of a user device in accordance with one or more embodiments of the present disclosure;

FIG. 6 illustrates an example GUI rendered on a display of a user device in accordance with one or more embodiments of the present disclosure;

FIG. 7 illustrates an example GUI rendered on a display of a user device in accordance with one or more embodiments of the present disclosure; and

FIG. 8 illustrates a flowchart of an example method in accordance with one or more embodiments of the present disclosure.

### DETAILED DESCRIPTION

Some embodiments of the present disclosure will now be described more fully herein with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

The use of the term “circuitry” as used herein with respect to components of a system, or an apparatus should be understood to include particular hardware configured to perform the functions associated with the particular circuitry as described herein. The term “circuitry” should be understood broadly to include hardware and, in some embodiments, software for configuring the hardware. For example, in some embodiments, “circuitry” may include processing circuitry, communication circuitry, input/output circuitry, and the like. In some embodiments, other elements may provide or supplement the functionality of particular circuitry. Alternatively, or additionally, in some embodiments, other elements of a system and/or apparatus described herein may provide or supplement the functionality of another particular set of circuitry. For example, a processor may provide processing functionality to any of the sets of circuitry, a memory may provide storage functionality to any of the sets of circuitry, communications circuitry may provide network interface functionality to any of the sets of circuitry, and/or the like.

As used herein, the terms “data,” “information,” and similar terms may be used interchangeably to refer to data capable of being transmitted, received, and/or stored in accordance with embodiments of the present disclosure. Thus, use of any such terms should not be taken to limit the spirit and scope of embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be sent directly to another computing device or may be sent indirectly via one or more intermediary computing devices, such as, for example, one or more servers, relays, routers, network access points, base stations, hosts, and/or the like.

The terms “computer-readable storage medium” refers to a non-transitory, physical or tangible storage medium (e.g., volatile or non-volatile memory), which may be differentiated from a “computer-readable transmission medium,” which refers to an electromagnetic signal.

As used herein, the term “computing device” refers to computer hardware and/or software that is configured to access functionality of and/or communicate with the resource allocation system. Computing devices may include, without limitation, smart phones, tablet computers, laptop computers, wearables, personal computers, enterprise computers, and the like.

As used herein, “application” refers to any program code executable by logic circuitry of one or more computing devices, such as a server processor. In some embodiments, an application is a computer program accessible to an entity via a computing device and which performs a specific function directly or indirectly for the entity, the computing device, another application, and/or the like. In some embodiments, an application includes a local software program installed and executed on a computing device accessible to an entity. In some embodiments, an application includes a remotely executed software program accessible to the entity via a computing device of the entity and a suitable network connection to the corresponding remote computing environment.

As used herein, the term “project” refers to any number of programs, initiatives, and/or the like, that include computer-performed tasks, computer-aided tasks, user-performed tasks, and/or the like. A task may be a specific unit of work, activity, or objective that may be completed in furtherance of a project. In some embodiments, projects include development of hardware, software, firmware, and/or the like. In various embodiments, a project is associated with a plurality of resources that may be used or consumed to complete or maintain the project. In some embodiments, a project is associated with one or more requirements. In various embodiments, a project is associated with one or more profiles comprising data associated with the project. For example, a profile of a project may include project design electronic records, resource impact value electronic records (e.g., a resource cost electronic record), project proposal electronic records, project requirement electronic requirement records, and/or the like. In this manner, a respective profile may embody or comprise project designs, project requirements, project proposals, resource impact values (e.g., resource cost), and/or the like.

As used herein, the term “resource” refers to an allocatable entity that may contribute to a project, or task thereof. In various embodiments, resources include computing resources, personnel, equipment, facilities, and/or the like.

As used herein, the term “parameter” includes any property, characteristic, or criteria associated with a project, a resource, and/or the like. For example, parameters of a project may include project proposals, project specifications, project requirements, resource impact value records, and/or the like. As another example, parameters of a resource include impact value, availability, stability, performance, quality, and/or the like.

As used herein, the term “requirement” refers to any rule, policy, constraint, requirement, and/or the like that is to be satisfied by a project and/or must be met in order to implement a project. For example, requirements may include rules or policies pursuant to projects impact values, resources, performance, timeliness, scope, safety, quality, and/or the like. In some embodiments, a requirement may be referred to as a requirement feature.

As used herein, the term “dataset” includes any data that is associated with a project. For example, a dataset may include project documentation electronic records, project-related communications, project resource information, project customer information, and/or the like.

As used herein, the term “data object” refers to any digital representation of information that characterizes or describes one or more aspects of a project. For example, a data object may include digital files (e.g., documents, images, videos, audio, and/or the like) that represent project designs, project resources, project proposals, project requirements, customer requests, project objectives, and/or the like.

As used herein, the term “natural language” refers to textual information, or an utterance of textual information, intelligible to human users and in accordance with parlance of the human users. For example, natural language may comprise a body of textual content that defines a grammatically accurate and typographically correct series of phrases, sentences, paragraphs, and/or the like.

As used herein, the term “natural language input” refers to textual information that originates from one or more inputs of a human user. For example, natural language input may include textual content that is inputted by a user into a computing device. As another example, a natural language input may include recorded human speech based upon which textual information may be generated.

As used herein, the term “prompt” refers to a natural language text that requests a machine learning model to perform one or more tasks. For example, a natural language instruction may comprise natural language text that requests a large language model to generate, modify, or transmit a project proposal, project specification, resource impact value record, and/or the like.

As used herein, the term “natural language output” refers to natural language text that is generated by a machine learning model. For example, a natural language output may comprise output of an LLM. In some embodiments, natural language output includes non-textual content outputted by a generative AI model. For example, natural language output may include natural language text generated by an LLM, and one or more images generated by an image generation model. As another example, natural language output may include utterances of natural language text, such as in the form of computer voice-based audio.

As used herein, the term “media element” refers to any data object capable of being outputted to a user by visual, audio, or audiovisual means. For example, a media element may include a depiction or utterance of textual information, an image of a component, a video of a component diagram, and/or the like.

As used herein, the term “electronic record” refers to any computer-coded representation of information. For example, an electronic record may include document files, image files, video files, three-dimensional design files, audio files, and/or the like, comprising project-related information, resource-related information, and/or the like.

As used herein, the term “embedding” refers to a numerical representation of data in one or more dimensions. For example, an embedding may include a vector representation of a natural language input that enables consumption of the natural language input by machine learning models.

As used herein, the term “machine learning model” refers to any algorithmic and/or machine learning model that comprises hardware and/or software that generates text, images, videos, or other data based at least in part on one or more instructions provided in a natural language format. In some embodiments, a machine learning model includes one or more large language models (LLMs) including autoregressive language models, autoencoding language models, and/or the like. Additionally, or alternatively, in some embodiments, a machine learning model comprises an architecture based at least in part on generative adversarial networks (GANs), variational autoencoders (VAEs), autoregressive models, recurrent neural networks (RNNs), transformers, image generators, and/or the like. In various embodiments, a machine learning model is configured to perform retrieval-augmented generation (RAG) techniques to enhance, expand, or augment data that is consumed by the machine learning model to generate an output based on one or more input instructions. In some embodiments, a machine learning model includes one or more attention mechanisms that enable a machine learning model to weight the respective influence or contribution of subsets of input data. In various embodiments, attention mechanisms include self-attention, scaled dot-product attention, multi-head attention, location-based attention, and/or the like. In some embodiments, machine learning model comprises a plurality of layers with each layer configured to perform one or more operations described herein. For example, a first layer of the plurality of layers may be configured to generate at least one data object. As another example, a second layer may be configured to generate at least one natural language output based on the at least one data object generated by the first layer of the plurality of layers.

### Overview

Example embodiments disclosed herein address technical problems associated with systems, apparatuses, methods, and computer program products for automated project quality control. As would be understood by one skilled in the field to which this disclosure pertains, there are numerous example scenarios in which systems, apparatuses, methods, and computer program products for automated project quality control.

Technical projects may include thousands to millions of data points and interactions that impact project quality. Each stage of a project (e.g., design, authorization, implementation, procurement, and/or the like) may involve generating, reviewing, and approving numerous project parameters to achieve cohesion between interrelated systems, entities, and processes as well as ensure compliance with project requirements, objectives, and standards. For example, development of a new vehicle system or a building control system may require generation, review, and approval of thousands of design files, proposals, and resource requests. Further, adjustments and approvals to any one project parameter may require coordination and communication between a diffuse network of agents. Project quality may be dependent upon effective performance in project planning, project documentation generation, and project parameter adjustment at scale and depth. Existing approaches typically rely upon computing devices to sequentially prepare, process, and verify each project material. Accordingly, such techniques demonstrate increasingly low efficiency and performance as the scale and complexity of projects increase.

The systems, apparatuses, methods, and computer program products provide an automated architecture to generate, review, and adjust project parameters and data over a project lifecycle to ensure quality and efficiency. For example, the systems, apparatuses, methods, and computer program products may generate interactive interfaces between automated project agents and tools and user entities. Further, the systems, apparatuses, methods, and computer program products may generate data objects in accordance with project parameters, such as project proposals, resource impact value summaries, project designs, and/or the like. In this manner, the described techniques may better control project quality by automating operations for generating project-related materials and providing human-machine interfaces for authorizing and administering the materials. Thus, to address these and/or other issues related to such example solutions, example systems, apparatuses, methods, and computer program products for automated project quality control are disclosed herein.

Further embodiments and advantages of the example systems, apparatuses, methods, and computer program products disclosed herein are described in the following co-pending U.S. patent applications: U.S. Application No. 63/790,880, titled SYSTEMS, APPARATUSES, METHODS, AND COMPUTER PROGRAM PRODUCTS FOR AUTOMATED PROJECT OPERATIONS ARCHITECTURE; U.S. Application No. 63/790,876, titled “SYSTEMS, APPARATUSES, METHODS, AND COMPUTER PROGRAM PRODUCTS FOR AN INTERACTIVE PROJECT REQUIREMENTS ANALYSIS ENGINE”; U.S. Application No. 63/790,873, titled “SYSTEMS, APPARATUSES, METHODS, AND COMPUTER PROGRAM PRODUCTS FOR A PROJECT OUTCOME PREDICTIVE ENGINE”; U.S. Application No. 63/790,878, titled “SYSTEMS, APPARATUSES, METHODS, AND COMPUTER PROGRAM PRODUCTS FOR NEW PROJECT GENERATION”; U.S. Application No. 63/790,875, titled “SYSTEMS, APPARATUSES, METHODS, AND COMPUTER PROGRAM PRODUCTS FOR GENERATING A NEW PHYSICAL COMPONENT”; U.S. Application No. 63/790,882, titled “SYSTEMS, APPARATUSES, METHODS, AND COMPUTER PROGRAM PRODUCTS FOR REAL-TIME PROJECT INVENTORY OPTIMIZATION”; U.S. Application No. 63/790,885, titled “SYSTEMS, APPARATUSES, METHODS, AND COMPUTER PROGRAM PRODUCTS FOR REAL-TIME PROJECT SERVICES OPERATIONS”; U.S. Application No. 63/790,889, titled “SYSTEMS, APPARATUSES, METHODS, AND COMPUTER PROGRAM PRODUCTS FOR PROJECT PROGRAM GENERATION”; and U.S. Application No. 63/790,879, titled “SYSTEMS, APPARATUSES, METHODS, AND COMPUTER PROGRAM PRODUCTS FOR AI DRIVEN PROJECT COMPLIANCE FORECASTING”, each of which is filed concurrently with the present application. The contents of each of the foregoing applications are hereby incorporated by reference in their entirety.

### Example Systems and Apparatuses

Embodiments of the present disclosure herein include systems, apparatuses, methods, and computer program products for automated project quality control. It should be readily appreciated that the embodiments of the apparatus, systems, methods, and computer program product described herein may be configured in various additional and alternative manners in addition to those expressly described herein.

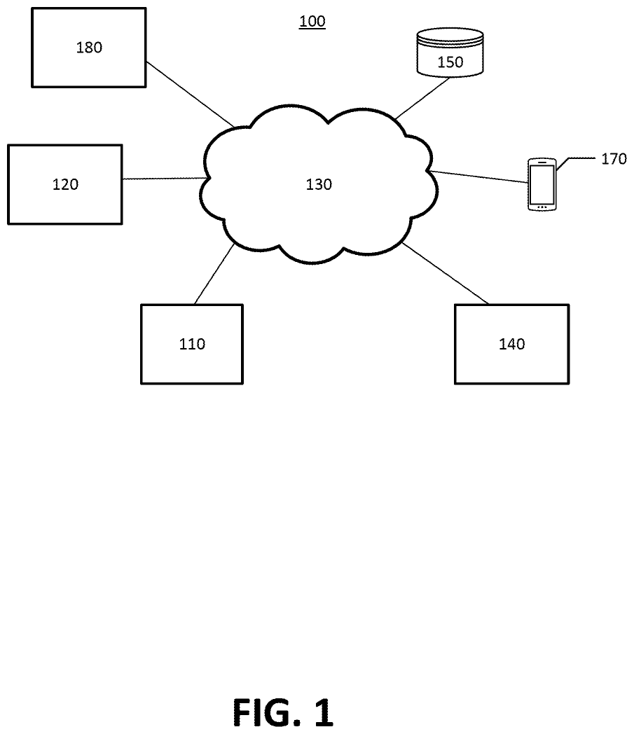

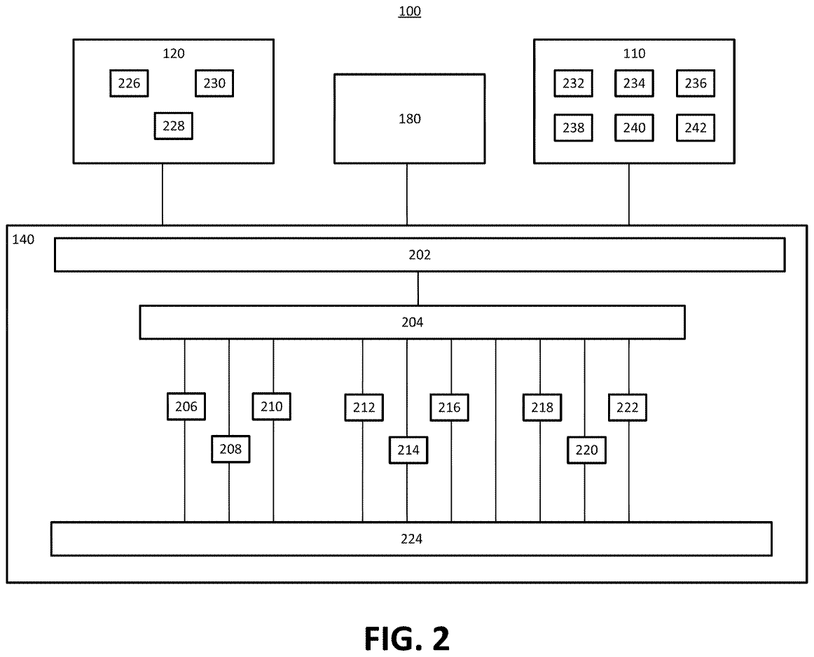

FIGS. 1 and 2 illustrate exemplary block diagrams of an environment 100 in which embodiments of the present disclosure may operate. In some embodiments, the environment 100 comprises a cloud-based project operations device 140. In some embodiments, the cloud-based project operations device 140 is electronically and/or communicatively coupled to a project foundation device 180, an external project implementation device 120, an external project application device 110, one or more databases 150, and/or the user device 170. The cloud-based project operations device 140 may be located remotely from the project foundation device 180, the external project implementation device 120, the external project application device 110, the one or more databases 150, and/or the user device 170. In this regard, for example, the cloud-based project operations device 140 may be located in a remote cloud server and electronically and/or communicatively coupled to the project foundation device 180, the external project implementation device 120, the external project application device 110, the one or more databases 150, and/or the user device 170 via at least the network 130. In some embodiments, the cloud-based project operations device 140 is configured via hardware, software, firmware, and/or a combination thereof, to perform data intake of one or more types of data.

Additionally, or alternatively, in some embodiments, the cloud-based project operations device 140 is configured via hardware, software, firmware, and/or a combination thereof, to generate and/or transmit command(s) that control, adjust, or otherwise impact operations of one or more of the project foundation device 180, the external project implementation device 120, the external project application device 110, the one or more databases 150, and/or the user device 170. Additionally, or alternatively, in some embodiments, the cloud-based project operations device 140 is configured via hardware, software, firmware, and/or a combination thereof, to perform data reporting, provide data, and/or other data output process(es) associated with monitoring or otherwise analyzing operations of one or more of the project foundation device 180, the external project implementation device 120, the external project application device 110, the one or more databases 150, and/or the user device 170. For example, in various embodiments, the cloud-based project operations device 140 may be configured to execute and/or perform one or more operations and/or functions described herein.

In some embodiments, the cloud-based project operations device 140 comprises a project operations security layer 202 configured to execute and/or perform one or more operations and/or functions described herein. For example, the project operations security layer 202 may be configured to control access permissions for the cloud-based project operations device 140. In some embodiments, the cloud-based project operations device 140 comprises a project orchestration predictive computing entity 204 configured to execute and/or perform one or more operations and/or functions described herein. In some embodiments, the cloud-based project operations device 140 comprises one or more internal predictive computing entities configured to execute and/or perform one or more operations and/or functions described herein. For example, the cloud-based project operations device 140 may comprise an inventory predictive computing entity 206, a program predictive computing entity 208, a project condition predictive computing entity 210, a project record predictive computing entity 212, a project component engineering predictive computing entity 214, a project command predictive computing entity 216, a project prompt predictive computing entity 218, a project operations predictive computing entity 220, a project services predictive computing entity 222, and/or the like. In some embodiments, the cloud-based project operations device 140 comprises an internal database 224 configured to execute and/or perform one or more operations and/or functions described herein. For example, the internal database 224 may be a vectorized database.

In some embodiments, the environment 100 comprises the external project implementation device 120. In some embodiments, the external project implementation device 120 is electronically and/or communicatively coupled to the project foundation device 180, the external project application device 110, the cloud-based project operations device 140, the one or more databases 150, and/or the user device 170. The external project implementation device 120 may be located remotely from the project foundation device 180, the external project application device 110, the cloud-based project operations device 140, the one or more databases 150, and/or the user device 170. In this regard, for example, the external project implementation device 120 may be located in a remote cloud server and electronically and/or communicatively coupled to the project foundation device 180, the external project application device 110, the cloud-based project operations device 140, the one or more databases 150, and/or the user device 170 via at least the network 130. In some embodiments, the external project implementation device 120 is configured via hardware, software, firmware, and/or a combination thereof, to perform data intake of one or more types of data.

Additionally, or alternatively, in some embodiments, the external project implementation device 120 is configured via hardware, software, firmware, and/or a combination thereof, to generate and/or transmit command(s) that control, adjust, or otherwise impact operations of one or more of the project foundation device 180, the external project application device 110, the cloud-based project operations device 140, the one or more databases 150, and/or the user device 170. Additionally, or alternatively, in some embodiments, the external project implementation device 120 is configured via hardware, software, firmware, and/or a combination thereof, to perform data reporting, provide data, and/or other data output process(es) associated with monitoring or otherwise analyzing operations of one or more of the project foundation device 180, the external project application device 110, the cloud-based project operations device 140, the one or more databases 150, and/or the user device 170. For example, in various embodiments, the external project implementation device 120 may be configured to execute and/or perform one or more operations and/or functions described herein.

In some embodiments, the external project implementation device 120 comprises one or more external predictive computing entities configured to execute and/or perform one or more operations and/or functions described herein. For example, the external project implementation device 120 may comprise a project extraction predictive computing entity 226, a project code predictive computing entity 228, a project bot predictive computing entity 230, and/or the like.

In some embodiments, the environment 100 comprises an external project application device 110. In some embodiments, the external project application device 110 is electronically and/or communicatively coupled to the project foundation device 180, the external project implementation device 120, the cloud-based project operations device 140, the one or more databases 150, and/or the user device 170. The external project application device 110 may be located remotely from the project foundation device 180, the external project implementation device 120, the cloud-based project operations device 140, the one or more databases 150, and/or the user device 170. In this regard, for example, the external project application device 110 may be located in a remote cloud server and electronically and/or communicatively coupled to the project foundation device 180, the external project implementation device 120, the cloud-based project operations device 140, the one or more databases 150, and/or the user device 170 via at least the network 130. In some embodiments, the external project application device 110 is configured via hardware, software, firmware, and/or a combination thereof, to perform data intake of one or more types of data.

Additionally, or alternatively, in some embodiments, the external project application device 110 is configured via hardware, software, firmware, and/or a combination thereof, to generate and/or transmit command(s) that control, adjust, or otherwise impact operations of one or more of the project foundation device 180, the external project implementation device 120, the cloud-based project operations device 140, the one or more databases 150, and/or the user device 170. Additionally, or alternatively, in some embodiments, the external project application device 110 is configured via hardware, software, firmware, and/or a combination thereof, to perform data reporting, provide data, and/or other data output process(es) associated with monitoring or otherwise analyzing operations of one or more of the project foundation device 180, the external project implementation device 120, the cloud-based project operations device 140, the one or more databases 150, and/or the user device 170. For example, in various embodiments, the external project application device 110 may be configured to execute and/or perform one or more operations and/or functions described herein.

In some embodiments, the external project application device 110 comprises one or more external computing applications configured to execute and/or perform one or more operations and/or functions described herein. For example, THE external project application device 110 may comprise a project operations computing application 232, a project impact value computing application 234, a project documentation computing application 236, a project component computing application 238, a project generation computing application 240, a project automation computing application 242, and/or the like.

In some embodiments, the environment 100 comprises the project foundation device 180. In some embodiments, the project foundation device 180 is electronically and/or communicatively coupled to the external project implementation device 120, the external project application device 110, the cloud-based project operations device 140, the one or more databases 150, and/or the user device 170. The project foundation device 180 may be located remotely from the external project implementation device 120, the external project application device 110, the cloud-based project operations device 140, the one or more databases 150, and/or the user device 170. In this regard, for example, the project foundation device 180 may be located in a remote cloud server and electronically and/or communicatively coupled to the external project implementation device 120, the external project application device 110, the cloud-based project operations device 140, the one or more databases 150, and/or the user device 170 via at least the network 130. In some embodiments, the project foundation device 180 is configured via hardware, software, firmware, and/or a combination thereof, to perform data intake of one or more types of data.

Additionally, or alternatively, in some embodiments, the project foundation device 180 is configured via hardware, software, firmware, and/or a combination thereof, to generate and/or transmit command(s) that control, adjust, or otherwise impact operations of one or more of the external project implementation device 120, the external project application device 110, the cloud-based project operations device 140, the one or more databases 150, and/or the user device 170. Additionally, or alternatively, in some embodiments, the project foundation device 180 is configured via hardware, software, firmware, and/or a combination thereof, to perform data reporting, provide data, and/or other data output process(es) associated with monitoring or otherwise analyzing operations of one or more of the external project implementation device 120, the external project application device 110, the cloud-based project operations device 140, the one or more databases 150, and/or the user device 170. For example, in various embodiments, the project foundation device 180 may be configured to execute and/or perform one or more operations and/or functions described herein.

The one or more databases 150 may be configured to receive, store, and/or transmit data. In some embodiments, the one or more databases 150 may be associated with data associated with the project foundation device 180, the external project implementation device 120, the external project application device 110, the cloud-based project operations device 140, and/or the user device 170. In some embodiments, the data may be received from the project foundation device 180, the external project implementation device 120, the external project application device 110, the cloud-based project operations device 140, and/or the user device 170. In some embodiments, the one or more databases 150 may be associated with data received from the project foundation device 180, the external project implementation device 120, the external project application device 110, the cloud-based project operations device 140, and/or the user device 170 in real-time. Additionally, or alternatively, the one or more databases 150 may be associated with data received from the project foundation device 180, the external project implementation device 120, the external project application device 110, the cloud-based project operations device 140, and/or the user device 170 on a periodic basis (e.g., the data may be received from the project foundation device 180, the external project implementation device 120, the external project application device 110, the cloud-based project operations device 140, the one or more databases 150, and/or the user device 170 once per day). Additionally, or alternatively, the one or more databases 150 may be associated with data received from the project foundation device 180, the external project implementation device 120, the external project application device 110, the cloud-based project operations device 140, and/or the user device 170 in response to a request for the data. Additionally, or alternatively, the one or more databases 150 may be associated with data inputted (e.g., by a user) into the project foundation device 180, the external project implementation device 120, the external project application device 110, the cloud-based project operations device 140, and/or the user device 170.

The user device 170 may be associated with users of the project foundation device 180, the external project implementation device 120, the external project application device 110, the cloud-based project operations device 140, and/or the one or more databases 150. In various embodiments, the project foundation device 180, the external project implementation device 120, the external project application device 110, the cloud-based project operations device 140, and/or the one or more databases 150 may generate and/or transmit a message, alert, or indication to a user via a user device 170. Additionally, or alternatively, a user device 170 may be utilized by a user to remotely access the project foundation device 180, the external project implementation device 120, the external project application device 110, the cloud-based project operations device 140, and/or the one or more databases 150. This may be by, for example, an application operating on the user device 170. A user may access the project foundation device 180, the external project implementation device 120, the external project application device 110, the cloud-based project operations device 140, and/or the one or more databases 150, remotely, including one or more visualizations, reports, and/or real-time displays.

In some embodiments, the project foundation device 180, the external project implementation device 120, the external project application device 110, the cloud-based project operations device 140, the one or more databases 150, and/or the user device 170 is associated with a determinable location. In some embodiments, the determinable location of the project foundation device 180, the external project implementation device 120, the external project application device 110, the cloud-based project operations device 140, the one or more databases 150, and/or the user device 170 represents an absolute position (e.g., GPS coordinates, latitude, and longitude locations, and/or the like) and/or a relative position (e.g., a point representation of the location of the project foundation device 180, the external project implementation device 120, the external project application device 110, the cloud-based project operations device 140, the one or more databases 150, and/or the user device 170 from a local origin point). In some embodiments, the project foundation device 180, the external project implementation device 120, the external project application device 110, the cloud-based project operations device 140, the one or more databases 150, and/or the user device 170 includes or otherwise is associated with a location sensor and/or software-driven location services that provide the location data representing the location corresponding to that the project foundation device 180, the external project implementation device 120, the external project application device 110, the cloud-based project operations device 140, the one or more databases 150, and/or the user device 170. In other embodiments the location of the project foundation device 180, the external project implementation device 120, the external project application device 110, the cloud-based project operations device 140, the one or more databases 150, and/or the user device 170 is stored and/or otherwise predetermined within a software environment, provided by a user and/or otherwise determinable to one or more systems.

Additionally, while FIGS. 1 and 2 illustrate certain components as separate, standalone entities communicating over the network 130, various embodiments are not limited to this configuration. In other embodiments, one or more components may be directly connected and/or share hardware or the like.

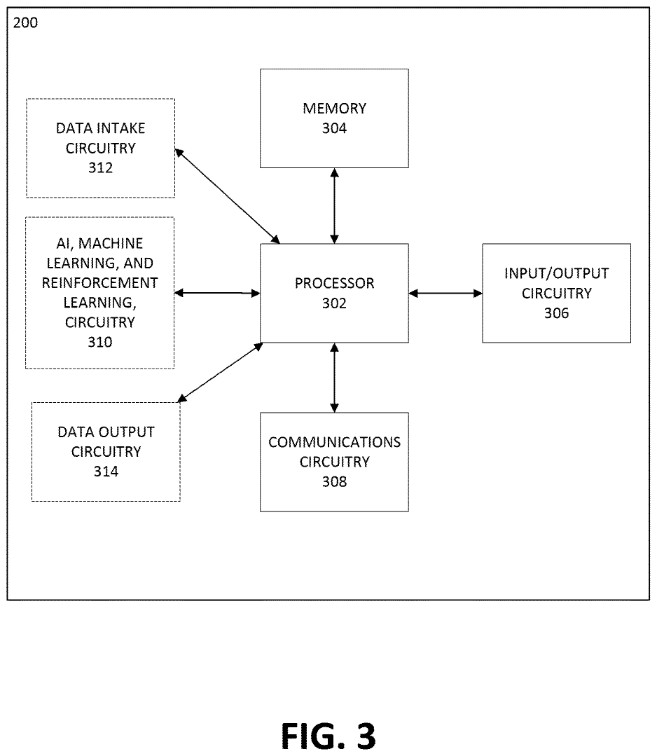

FIG. 3 illustrates an exemplary block diagram of an example apparatus that may be specially configured in accordance with an example embodiment of the present disclosure. Specifically, FIG. 3 depicts an example computing apparatus 300 (“apparatus 300”) specially configured in accordance with at least some example embodiments of the present disclosure. For example, the computing apparatus 300 may be embodied as one or more of a specifically configured personal computing apparatus, a specifically configured cloud-based computing apparatus, a specifically configured embedded computing device (e.g., configured for edge computing, and/or the like). Examples of an apparatus 300 may include, but is not limited to, the project foundation device 180, the external project implementation device 120, the external project application device 110, the cloud-based project operations device 140, the one or more databases 150, and/or the user device 170. The apparatus 300 includes processor 302, memory 304, input/output circuitry 306, communications circuitry 308, and/or optional artificial intelligence (“AI”) and machine learning circuitry 310. In some embodiments, the apparatus 300 is configured to execute and perform the operations described herein.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), memory(ies), circuitry(ies), and/or the like to perform their associated functions such that duplicate hardware is not required for each set of circuitry.

In various embodiments, such as computing apparatus 300 of the project foundation device 180, the external project implementation device 120, the external project application device 110, the cloud-based project operations device 140, the one or more databases 150, and/or the user device 170 may refer to, for example, one or more computers, computing entities, desktop computers, mobile phones, tablets, phablets, notebooks, laptops, distributed systems, servers, or the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein. In one embodiment, these functions, operations, and/or processes can be performed on data, content, information, and/or similar terms used herein. In this regard, the apparatus 300 embodies a particular, specially configured computing entity transformed to enable the specific operations described herein and provide the specific advantages associated therewith, as described herein.

Processor 302 or processor circuity 302 may be embodied in a number of different ways. In various embodiments, the use of the terms “processor” should be understood to include a single core processor, a multi-core processor, multiple processors internal to the apparatus 300, and/or one or more remote or “cloud” processor(s) external to the apparatus 300. In some example embodiments, processor 302 may include one or more processing devices configured to perform independently. Alternatively, or additionally, processor 302 may include one or more processor(s) configured in tandem via a bus to enable independent execution of operations, instructions, pipelining, and/or multithreading.

In an example embodiment, the processor 302 may be configured to execute instructions stored in the memory 304 or otherwise accessible to the processor. Alternatively, or additionally, the processor 302 may be configured to execute hard-coded functionality. As such, whether configured by hardware or software methods, or by a combination thereof, processor 302 may represent an entity (e.g., physically embodied in circuitry) capable of performing operations according to embodiments of the present disclosure while configured accordingly. Alternatively, or additionally, processor 302 may be embodied as an executor of software instructions, and the instructions may specifically configure the processor 302 to perform the various algorithms embodied in one or more operations described herein when such instructions are executed. In some embodiments, the processor 302 includes hardware, software, firmware, and/or a combination thereof that performs one or more operations described herein.

In some embodiments, the processor 302 (and/or co-processor or any other processing circuitry assisting or otherwise associated with the processor) is/are in communication with the memory 304 via a bus for passing information among components of the apparatus 300.

Memory 304 or memory circuitry 304 may be non-transitory and may include, for example, one or more volatile and/or non-volatile memories. In some embodiments, the memory 304 includes or embodies an electronic storage device (e.g., a computer readable storage medium). In some embodiments, the memory 304 is configured to store information, data, content, applications, instructions, or the like, for enabling an apparatus 300 to carry out various operations and/or functions in accordance with example embodiments of the present disclosure.

Input/output circuitry 306 may be included in the apparatus 300. In some embodiments, input/output circuitry 306 may provide output to the user and/or receive input from a user. The input/output circuitry 306 may be in communication with the processor 302 to provide such functionality. The input/output circuitry 306 may comprise one or more user interface(s). In some embodiments, a user interface may include a display that comprises the interface(s) rendered as a web user interface, an application user interface, a user device, a backend system, or the like. In some embodiments, the input/output circuitry 306 also includes a keyboard, a mouse, a joystick, a touch screen, touch areas, soft keys a microphone, a speaker, or other input/output mechanisms. The processor 302 and/or input/output circuitry 306 comprising the processor may be configured to control one or more operations and/or functions of one or more user interface elements through computer program instructions (e.g., software and/or firmware) stored on a memory accessible to the processor (e.g., memory 304, and/or the like). In some embodiments, the input/output circuitry 306 includes or utilizes a user-facing application to provide input/output functionality to a computing device and/or other display associated with a user.

Communications circuitry 308 may be included in the apparatus 300. The communications circuitry 308 may include any means such as a device or circuitry embodied in either hardware or a combination of hardware and software that is configured to receive and/or transmit data from/to a network and/or any other device, circuitry, or module in communication with the apparatus 300. In some embodiments the communications circuitry 308 includes, for example, a network interface for enabling communications with a wired or wireless communications network. Additionally, or alternatively, the communications circuitry 308 may include one or more network interface card(s), antenna(s), bus(es), switch(es), router(s), modem(s), and supporting hardware, firmware, and/or software, or any other device suitable for enabling communications via one or more communications network(s). In some embodiments, the communications circuitry 308 may include circuitry for interacting with an antenna(s) and/or other hardware or software to cause transmission of signals via the antenna(s) and/or to handle receipt of signals received via the antenna(s). In some embodiments, the communications circuitry 308 enables transmission to and/or receipt of data from a user device, one or more sensors, and/or other external computing device(s) in communication with the apparatus 300.

Data intake circuitry 312 may be included in the apparatus 300. The data intake circuitry 312 may include hardware, software, firmware, and/or a combination thereof, designed and/or configured to capture, receive, request, and/or otherwise gather data associated with operations of the project foundation device 180, the external project implementation device 120, the external project application device 110, the cloud-based project operations device 140, the one or more databases 150, and/or the user device 170. In some embodiments, the data intake circuitry 312 includes hardware, software, firmware, and/or a combination thereof, that communicates with one or more sensor(s) unit(s), and/or the like within the project foundation device 180, the external project implementation device 120, the external project application device 110, the cloud-based project operations device 140, the one or more databases 150, and/or the user device 170 to receive particular data. Additionally, or alternatively, in some embodiments, the data intake circuitry 312 includes hardware, software, firmware, and/or a combination thereof, that retrieves particular data associated with the project foundation device 180, the external project implementation device 120, the external project application device 110, the cloud-based project operations device 140, the one or more databases 150, and/or the user device 170 from one or more data repository/repositories accessible to the apparatus 300.

AI and machine learning circuitry 310 may be included in the apparatus 300. The AI and machine learning circuitry 310 may include hardware, software, firmware, and/or a combination thereof designed and/or configured to request, receive, process, generate, and transmit data, data structures, control signals, and electronic information for training and executing a trained AI and machine learning model configured for facilitating the operations and/or functionalities described herein. For example, in some embodiments the AI and machine learning circuitry 310 includes hardware, software, firmware, and/or a combination thereof, that identifies training data and/or utilizes such training data for training a particular machine learning model, AI, and/or other model to generate particular output data based at least in part on learnings from the training data. Additionally, or alternatively, in some embodiments, the AI and machine learning circuitry 310 includes hardware, software, firmware, and/or a combination thereof, that embodies or retrieves a trained machine learning model, AI and/or other specially configured model utilized to process inputted data. Additionally, or alternatively, in some embodiments, the AI and machine learning circuitry 310 includes hardware, software, firmware, and/or a combination thereof that processes received data utilizing one or more algorithm(s), function(s), subroutine(s), and/or the like, in one or more pre-processing and/or subsequent operations that need not utilize a machine learning or AI model.

Data output circuitry 314 may be included in the apparatus 300. The data output circuitry 314 may include hardware, software, firmware, and/or a combination thereof, that configures and/or generates an output based at least in part on data processed by the apparatus 300. In some embodiments, the data output circuitry 314 includes hardware, software, firmware, and/or a combination thereof, that generates a particular report based at least in part on the processed data, for example where the report is generated based at least in part on a particular reporting protocol. Additionally, or alternatively, in some embodiments, the data output circuitry 314 includes hardware, software, firmware, and/or a combination thereof, that configures a particular output data object, output data file, and/or user interface for storing, transmitting, and/or displaying. For example, in some embodiments, the data output circuitry 314 generates and/or specially configures a particular data output for transmission to another system sub-system for further processing. Additionally, or alternatively, in some embodiments, the data output circuitry 314 includes hardware, software, firmware, and/or a combination thereof, that causes rendering of a specially configured user interface based at least in part on data received by and/or processing by the apparatus 300.

In some embodiments, two or more of the sets of circuitries 302-314 are combinable. Alternatively, or additionally, one or more of the sets of circuitry 302-314 perform some or all of the operations and/or functionality described herein as being associated with another circuitry. In some embodiments, two or more of the sets of circuitry 302-314 are combined into a single module embodied in hardware, software, firmware, and/or a combination thereof. For example, in some embodiments, one or more of the sets of circuitry, for example the AI and machine learning circuitry 310, may be combined with the processor 302, such that the processor 302 performs one or more of the operations described herein with respect to the AI and machine learning circuitry 310.

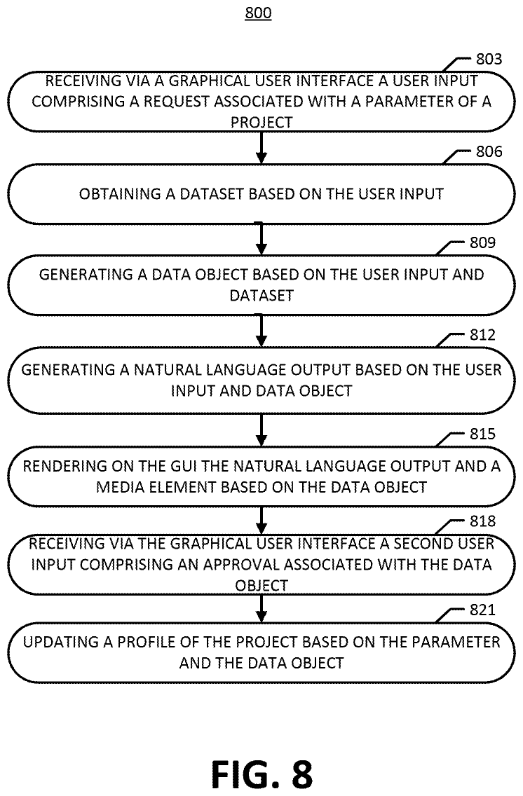

In various embodiments, the present apparatuses, methods, computer program products, and/or the like are configured to carry out functionality for automated project quality control. For example, the project foundation device 180, the external project implementation device 120, the external project application device 110, the cloud-based project operations device 140, and/or the like may perform, via one or more apparatuses 300, the method 800 shown in FIG. 8 and described herein to generate conversational interfaces, generate data objects associated with projects and parameters thereof, and obtain approval of data objects, parameters, and/or the like. In doing so, the project foundation device 180, the external project implementation device 120, the external project application device 110, the cloud-based project operations device 140, and/or the like may automate project quality control processes, increasing the efficiency and scalability of project planning, management, and execution.

In various embodiments, the project foundation device 180, the external project implementation device 120, the external project application device 110, the cloud-based project operations device 140, and/or the like train and execute machine learning models, such as large language models (LLMs), to generate interactive conversational interfaces by which aspects of a project may be generated, modeled, adjusted, and approved using natural language-based inputs and outputs. In this manner, the described techniques may provide precise real-time human-machine interfaces for controlling project quality. In some embodiments, the project foundation device 180, the external project implementation device 120, the external project application device 110, the cloud-based project operations device 140, and/or the like train LLMs based at least in part on user inputs, such as modifications to generated data objects.

For example, the project foundation device 180, the external project implementation device 120, the external project application device 110, the cloud-based project operations device 140, and/or the like may obtain from user input one or more modifications to one or more data objects generated using an LLM, such as project design electronic records, resource impact value electronic records, project proposal electronic records, project requirement electronic requirement records, and/or the like. The project foundation device 180, the external project implementation device 120, the external project application device 110, the cloud-based project operations device 140, and/or the like may modify the one or more data objects based at least in part on the user input. Further, the project foundation device 180, the external project implementation device 120, the external project application device 110, the cloud-based project operations device 140, and/or the like may retrain the LLM and/or other models used to generate the data object based at least in part on the user input, the modified data objects, and/or the like. In doing so, the project foundation device 180, the external project implementation device 120, the external project application device 110, the cloud-based project operations device 140, and/or the like may provide advantages including increasing the accuracy and quality of data objects, customizing the style or composition of data objects in accordance with user or customer objectives, increasing the efficiency of subsequent generative processes, and/or the like.

In some embodiments, the project foundation device 180, the external project implementation device 120, the external project application device 110, the cloud-based project operations device 140, and/or the like, trains and store multiple different instances of an LLM. The multiple instances of the LLM may be associated with different users, customers, project types, and/or the like. In doing so, the project foundation device 180, the external project implementation device 120, the external project application device 110, the cloud-based project operations device 140, and/or the like may generate, train, and maintain instances of an LLM that are customized in accordance with preferences or requires of the associated user, customer, project type, and/or the like. In some embodiments, the project foundation device 180, the external project implementation device 120, the external project application device 110, the cloud-based project operations device 140, and/or the like may determine whether to cross-train or otherwise update other instances of the LLM based on a particular LLM. For example, the project foundation device 180, the external project implementation device 120, the external project application device 110, the cloud-based project operations device 140, and/or the like may be configured to determine whether a user inputted modification, based on which one instance of an LLM is retrained, may be utilized as a basis for training other instances of the LLM.

In some embodiments, the determination of whether to cross-train or update other instances of the LLM is based on an analysis of the user input, modification, and/or the like, which may be performed at least in part using machine learning techniques, such as reinforcement learning. For example, the project foundation device 180, the external project implementation device 120, the external project application device 110, the cloud-based project operations device 140, and/or the like may determine whether a user input, modification, and/or the like is associated with effecting a subjective change (e.g., accommodating stylistic preferences) or an objective change (e.g., correcting for compositional or structural errors). In this manner, the project foundation device 180, the external project implementation device 120, the external project application device 110, the cloud-based project operations device 140, and/or the like may train a plurality of instances of LLMs in a federated manner, distributing or siloing model updates based on analyses of the conditions arising to the modifications to a model instance.

In some embodiments, the project foundation device 180, the external project implementation device 120, the external project application device 110, the cloud-based project operations device 140, and/or the like process natural language inputs from a user entity to determine one or more intents of the user entity, including requests, adjustments, approvals, rejections, and/or the like. For example, the project foundation device 180, the external project implementation device 120, the external project application device 110, the cloud-based project operations device 140, and/or the like may execute one or more machine learning models on input derived from or comprising a natural language-based user input. In doing so, the project foundation device 180, the external project implementation device 120, the external project application device 110, the cloud-based project operations device 140, and/or the like may obtain as output requested data objects, modified data objects, and/or the like. In some embodiments, the project foundation device 180, the external project implementation device 120, the external project application device 110, the cloud-based project operations device 140, and/or the like generate, using one or more machine learning models, one or more embeddings based at least in part on natural language inputs. For example, the project foundation device 180, the external project implementation device 120, the external project application device 110, the cloud-based project operations device 140, and/or the like may generate vector representations of terms in a natural language input, or subsets thereof.

In various embodiments, the project foundation device 180, the external project implementation device 120, the external project application device 110, the cloud-based project operations device 140, and/or the like, generates, via a respective attention mechanism of one or more machine learning models, a plurality of attention weights associated with different subsets of a natural language input, a dataset obtained based thereon, a data object, and/or the like. The attention weights may determine the relative contribution or importance attributed to the associated element when generating a machine learning output. For example, attention weights may be utilized by an LLM to prioritize subsets of a natural language input or other model input when generating a data object, natural language output, and/or the like. In some embodiments, the project foundation device 180, the external project implementation device 120, the external project application device 110, the cloud-based project operations device 140, and/or the like are configured to perform one or more retrieval-augmented generation (RAG) techniques based at least in part on model inputs and associated attention weights to determine additional relevant data that may be consumed as input by a machine learning model.

In some embodiments, the project foundation device 180, the external project implementation device 120, the external project application device 110, the cloud-based project operations device 140, and/or the like generate data objects via one or more machine learning models. For example, the project foundation device 180, the external project implementation device 120, the external project application device 110, the cloud-based project operations device 140, and/or the like may generate project design electronic records, resource impact value electronic records, project proposal electronic records, project requirement electronic requirement records, other documentation based at least in part on execution of an LLM on input derived from or comprising an instruction from a user entity. In this manner, the project foundation device 180, the external project implementation device 120, the external project application device 110, the cloud-based project operations device 140, and/or the like may automate processes for generating data objects by which project quality, project process, and/or the like may be monitored and validated.

In various embodiments, the project foundation device 180, the external project implementation device 120, the external project application device 110, the cloud-based project operations device 140, and/or the like generate natural language outputs, media elements, and/or the like that may be rendered on GUIs, enabling user entities to view and respond to the digital content. For example, the project foundation device 180, the external project implementation device 120, the external project application device 110, the cloud-based project operations device 140, and/or the like may generate and update a GUI based at least in part on one or more successions of natural language inputs (e.g., from the user entity) and natural language outputs (e.g., generated via the described techniques).

The GUI may be further updated based at least in part on datasets obtained and data objects generated in response to user inputs. For example, the project foundation device 180, the external project implementation device 120, the external project application device 110, the cloud-based project operations device 140, and/or the like may obtain one or more datasets based at least in part on a user input comprising a request pursuant to a parameter of a project (e.g., project proposal, project design, resource allocation, resource procurement, and/or the like). The project foundation device 180, the external project implementation device 120, the external project application device 110, the cloud-based project operations device 140, and/or the like may generate or retrieve data objects, such as project design electronic records, resource impact value electronic records, project proposal electronic records, project requirement electronic requirement records, and/or the like, based at least in part on the datasets. The project foundation device 180, the external project implementation device 120, the external project application device 110, the cloud-based project operations device 140, and/or the like may generate and render on the GUI one or more media elements depicting or representing the data objects. In doing so, the project foundation device 180, the external project implementation device 120, the external project application device 110, the cloud-based project operations device 140, and/or the like may receive additional user input embodying a qualitative assessment of and/or modification to the data object, such as approval, adjustment, expansion, rejection, and/or the like of the data object. The project foundation device 180, the external project implementation device 120, the external project application device 110, the cloud-based project operations device 140, and/or the like may carry out additional functionality (e.g., adjusting data objects, provisioning data objects to other entities, initiating project-related processes, and/or the like) based on additional user inputs to the GUI. In this manner, the project foundation device 180, the external project implementation device 120, the external project application device 110, the cloud-based project operations device 140, and/or the like may automate project quality control processes, increasing speed and efficiency of project implementation.

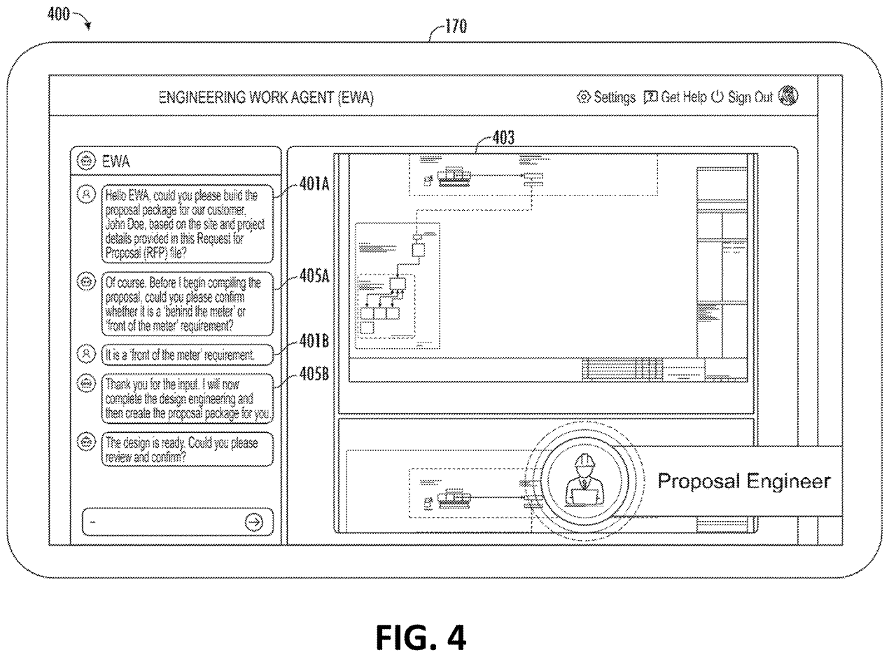

Referring now to FIGS. 4-7, various example graphical user interfaces (GUIs) are shown. In various embodiments, the project foundation device 180, the external project implementation device 120, the external project application device 110, the cloud-based project operations device 140, and/or the like may cause rendering of GUIs on one or more displays of the user device 170 to carry out functionality and perform operations described herein. For example, the project foundation device 180, the external project implementation device 120, the external project application device 110, the cloud-based project operations device 140, and/or the like may receive user inputs from and provide outputs to the user device 170 via the GUIs. In doing so, the project foundation device 180, the external project implementation device 120, the external project application device 110, the cloud-based project operations device 140, and/or the like may carry out functionality and perform operations to automate project quality control. For example, the project foundation device 180, the external project implementation device 120, the external project application device 110, the cloud-based project operations device 140, and/or the like may enable, for a generated new project or an existing project, a dynamic review procedure comprising a real-time conversational interface by which parameters of a project and data objects associated with a project may be reviewed, adjusted, and approved by a user entity. For example, the present apparatuses, methods, and computer program products may enable a subject matter expert to use the real-time conversational interface to review a project parameter, command performance of automatic adjustments, and automatically initiate supply chain operations once the project parameter has been approved (e.g., ordering parts for the new project, modifying project-related data, and/or the like).

FIGS. 4, 5, and 6 illustrate, respectively, example graphical user interfaces (GUIs) 400, 500, 600 rendered on a display of a user device 170 in accordance with one or more embodiments of the present disclosure. The GUIs 400, 500, 600 may provide an example of an automated conversational interaction between a user entity and the project foundation device 180, the external project implementation device 120, the external project application device 110, the cloud-based project operations device 140, and/or the like. The project foundation device 180, the external project implementation device 120, the external project application device 110, the cloud-based project operations device 140, and/or the like may process user inputs via one or more algorithms, machine learning models, and/or the like to determine requests, instructions, queries, and/or the like that are defined by the natural language, selections, and/or the like inputted by the user entity.

For example, the project foundation device 180, the external project implementation device 120, the external project application device 110, the cloud-based project operations device 140, and/or the like may receive via the GUI 400 a user input 401A comprising a request for a parameter of a project, such as a construction of a proposal package. Based at least in part on the user input 401A, the project foundation device 180, the external project implementation device 120, the external project application device 110, the cloud-based project operations device 140, and/or the like may obtain one or more datasets associated with the project. The project foundation device 180, the external project implementation device 120, the external project application device 110, the cloud-based project operations device 140, and/or the like may generate a data object 403 based at least in part on the one or more datasets and the user input 401A. For example, the project foundation device 180, the external project implementation device 120, the external project application device 110, the cloud-based project operations device 140, and/or the like may generate a data object 403 including a project design electronic record for the proposal package requested by the user entity. Based at least in part on the dataset, the user input 401A, and/or the like, the project foundation device 180, the external project implementation device 120, the external project application device 110, the cloud-based project operations device 140, and/or the like may generate and render on the GUI 400 a natural language output 405A requesting additional user instruction regarding an aspect of the data object 403 (e.g., the project design electronic record for the proposal package). The project foundation device 180, the external project implementation device 120, the external project application device 110, the cloud-based project operations device 140, and/or the like may receive via the GUI 400 a second user input 401B comprising a response to the request. The project foundation device 180, the external project implementation device 120, the external project application device 110, the cloud-based project operations device 140, and/or the like may generate the data object 403 further based at least in part on the second user input 401B.

The project foundation device 180, the external project implementation device 120, the external project application device 110, the cloud-based project operations device 140, and/or the like may generate a natural language output 405B based at least in part on the data object 403, and the user input 401A. The project foundation device 180, the external project implementation device 120, the external project application device 110, the cloud-based project operations device 140, and/or the like may generate one or more media elements based at least in part on the data object 403. For example, the media element may comprise a rendering of content comprised in the data object 403. The rendering may be an inline frame, embedding, and/or the like. The natural language output 405B may indicate the generated data object 403, such as by identifying the rendered media element as a project design for the requested proposal package.

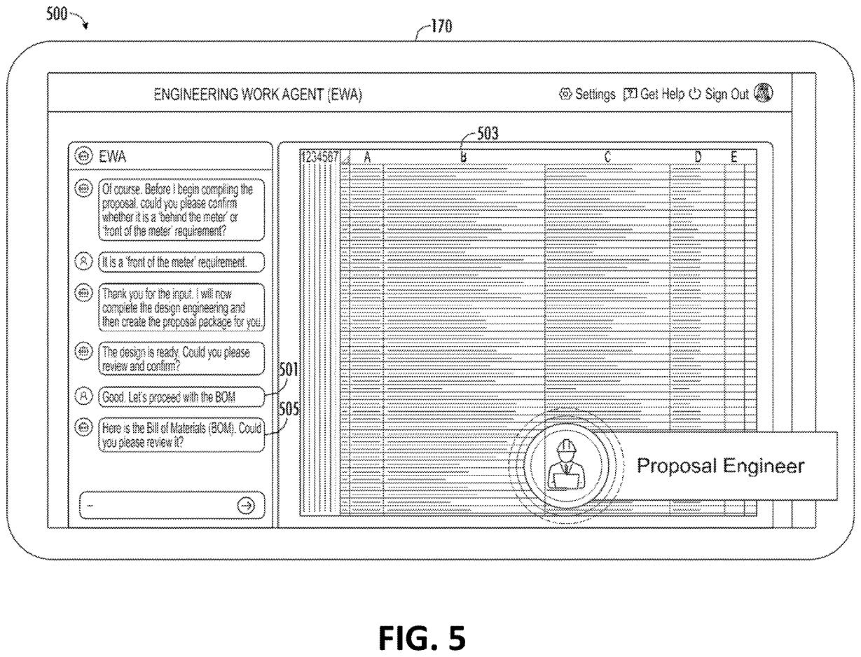

As shown in FIG. 5, the project foundation device 180, the external project implementation device 120, the external project application device 110, the cloud-based project operations device 140, and/or the like may receive via the GUI 500 a user input 501 comprising an approval of the data object 403. In response to the approval, the project foundation device 180, the external project implementation device 120, the external project application device 110, the cloud-based project operations device 140, and/or the like may perform one or more actions, such as updating a profile associated with the project based at least in part on the parameter, the dataset, the data object 403, and/or the like, provisioning the data object 403 to one or more entities, initiating one or more project-related operations, and/or the like. The user input 501 may comprise additional requests related to the project, such as additional parameters associated with the project. For example, the user input 501 may comprise a request to generate an electronic record indicative of project resource impact values related to the project proposal. Based at least in part on the user input 501, the project foundation device 180, the external project implementation device 120, the external project application device 110, the cloud-based project operations device 140, and/or the like may obtain one or more datasets and generate a second data object 503 based at least in part on the datasets, the user input 501, the data object 403, and/or the like. The second data object 503 may comprise, for example, a resource impact value electronic record.

In various embodiments, the project foundation device 180, the external project implementation device 120, the external project application device 110, the cloud-based project operations device 140, and/or the like generates a natural language output 505 and one or more media elements based at least in part on the data object 503, the associated datasets, the user input 501, and/or the like. The project foundation device 180, the external project implementation device 120, the external project application device 110, the cloud-based project operations device 140, and/or the like may render the natural language output 505 and the one or more media elements on the GUI 500, 600, enabling the user entity to access, view, adjust, and/or approve the resource impact value electronic record.

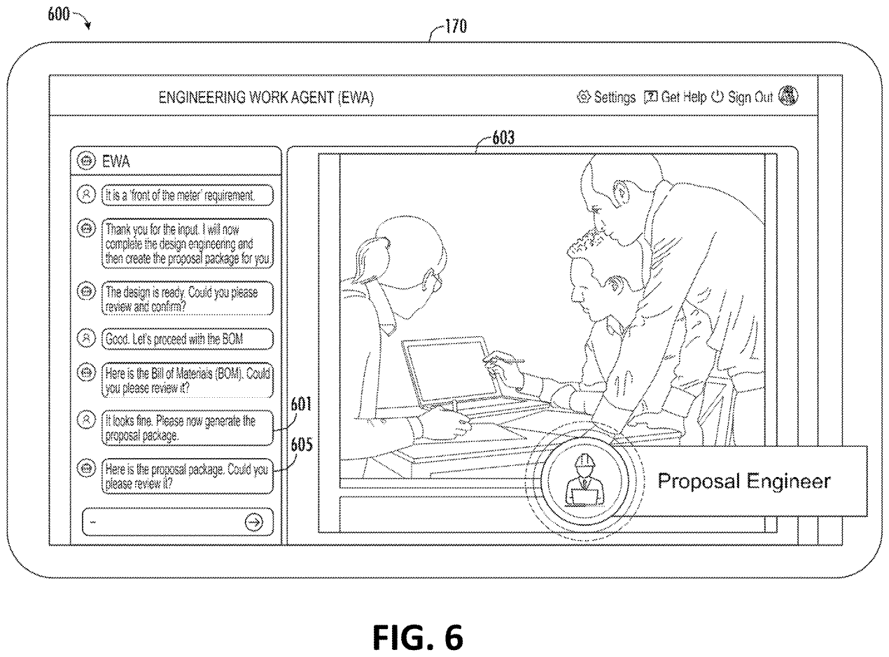

As further shown in FIG. 6, the project foundation device 180, the external project implementation device 120, the external project application device 110, the cloud-based project operations device 140, and/or the like may receive via the GUI 600 a user input 601 comprising an approval of the data object 503 (e.g., resource impact value electronic record). The user input 601 may further comprise an instruction to generate a data object (e.g., a project proposal electronic record) based at least in part on the data objects 403, 503, datasets, and/or the like The project foundation device 180, the external project implementation device 120, the external project application device 110, the cloud-based project operations device 140, and/or the like may obtain one or more datasets and generate a data object 603 based at least in part on the datasets, data object 403, data object 503, user input 601, and/or the like. For example, the external project implementation device 120, the external project application device 110, the cloud-based project operations device 140, and/or the like may generate a project proposal electronic record based at least in part on and/or comprising one or more resource impact value electronic records, project design electronic records, project requirement electronic records, and/or the like.

The project foundation device 180, the external project implementation device 120, the external project application device 110, the cloud-based project operations device 140, and/or the like may generate a natural language output 605 and a media element based at least in part on the data object 603. The project foundation device 180, the external project implementation device 120, the external project application device 110, the cloud-based project operations device 140, and/or the like may render on the GUI 600 the natural language output 605, the media element, and/or the like. The project foundation device 180, the external project implementation device 120, the external project application device 110, the cloud-based project operations device 140, and/or the like may receive further user input approving the project proposal. In response, the project foundation device 180, the external project implementation device 120, the external project application device 110, the cloud-based project operations device 140 may perform one or more actions, such as provisioning one or more data objects 403, 503, 603, to another entity, initiating one or more project operations, and/or the like.

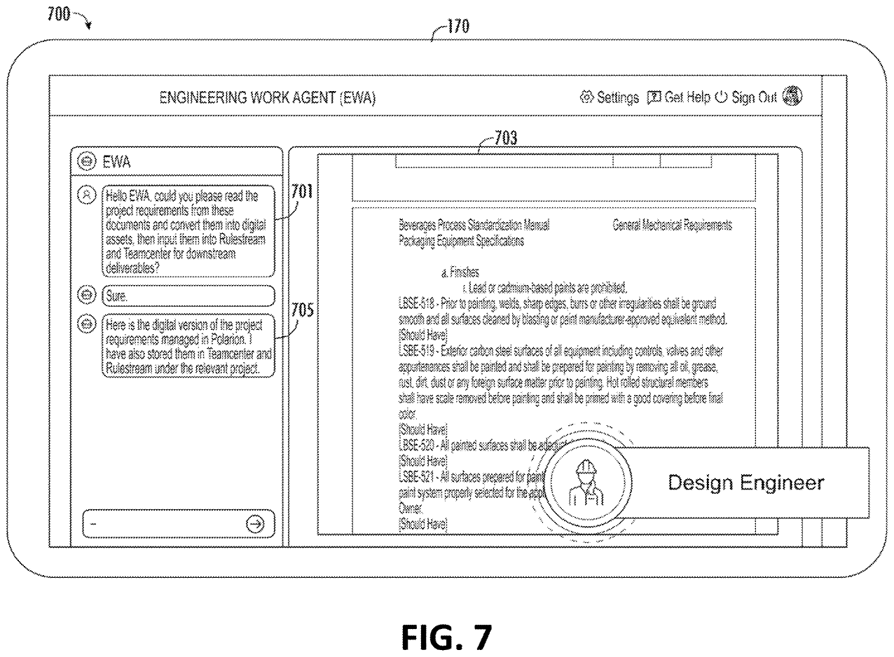

FIG. 7 illustrates an example GUI 700 rendered on a display of a user device 170 in accordance with one or more embodiments of the present disclosure. The GUI 700 may include another example of an automated conversational interaction between a user entity and the project foundation device 180, the external project implementation device 120, the external project application device 110, the cloud-based project operations device 140, and/or the like, which may be carried out to perform automatic quality control of a project.

In various embodiments, the project foundation device 180, the external project implementation device 120, the external project application device 110, the cloud-based project operations device 140, and/or the like receives user input 701 including a request for project requirements. In some embodiments, the user input indicates data related to the request. For example, the user input 701 may include a request for project requirements based at least in part on one or more project documentation electronic records. In various embodiments, a project documentation electronic record includes data related to parameters of the project, an entity on behalf of which the project is performed, or an entity that performs the project. For example, a project documentation electronic record may include data (e.g., in the form of document files, media files, communications, and/or the like) that indicate resource impact value thresholds, resource property requirements (e.g., type, quality, treatment, quantity, the like), time series project performance milestones, project completion thresholds, and/or the like.

In some embodiments, the project foundation device 180, the external project implementation device 120, the external project application device 110, the cloud-based project operations device 140, and/or the like generates a data object 703 based at least in part on the data indicated in the request of the user input 701. For example, the project foundation device 180, the external project implementation device 120, the external project application device 110, the cloud-based project operations device 140, and/or the like may determine a plurality of project requirements based at least in part on a project documentation electronic record. The project foundation device 180, the external project implementation device 120, the external project application device 110, the cloud-based project operations device 140, and/or the like may generate one or more project requirement electronic records based at least in part on a project documentation electronic record. In various embodiments, the project foundation device 180, the external project implementation device 120, the external project application device 110, the cloud-based project operations device 140, and/or the like causes rendering of a media element representative of the data object 703 on the GUI 700. For example, the project foundation device 180, the external project implementation device 120, the external project application device 110, the cloud-based project operations device 140, and/or the like may cause rendering of a document including a plurality of project requirements.

In some embodiments, the project foundation device 180, the external project implementation device 120, the external project application device 110, the cloud-based project operations device 140, and/or the like generates a natural language output 705 that indicates the data object 703 that was generated. In some embodiments, the project foundation device 180, the external project implementation device 120, the external project application device 110, the cloud-based project operations device 140, and/or the like generates natural language output indicating one or more project-related operations that were performed pursuant to the user input 701, the data object 703, and/or the like. For example, the project foundation device 180, the external project implementation device 120, the cloud-based project operations device 140, and/or the like may cause provision of one or more project requirement electronic records to an external project application device 110 to cause the external project application device 110 to perform one or more actions, such as extracting and storing project requirements, obtaining project performance timelines or resource impact value metrics based at least in part on the project requirements, and/or the like.

### Example Methods

Referring now to FIG. 8, a flowchart providing an example method 800 is illustrated. In this regard, FIG. 8 illustrates operations that may be performed by the project foundation device 180, the external project implementation device 120, the external project application device 110, the cloud-based project operations device 140, the one or more databases 150, and/or the user device 170. To describe example aspects of the method 800, the proceeding description is presented in the context of the cloud-based project operations device 140. In some embodiments, one or more operations of the method 800 are performed instead by the project foundation device 180, the external project implementation device 120, the external project application device 110, the one or more databases 150, and/or the user device 170.

In various embodiments, the method 800 comprises operations for, in response to receiving at least one user input to a graphical user interface (GUI) on a user device, accessing, at a project orchestration predictive computing entity, at least one dataset based at least in part on the at least one user input, wherein the at least one user input comprises a request associated with at least one parameter of a project; generating, using project record predictive computing entity, at least one data object based at least in part on the at least one user input and the at least one dataset; generating, using the project orchestration predictive computing entity, at least one natural language output based at least in part on the at least one user input and the at least one data object; causing rendering of at least one natural language output and at least one media element on the GUI, wherein the at least one media element is representative of the at least one data object; and in response receiving a second user input to the GUI comprising an approval of at least one component of the at least one data object, updating, using the project record predictive computing entity, at least one profile associated with the project based at least in part on the at least one parameter and the at least one data object. In some embodiments, the example method 800 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 800.

In some embodiments, at operation 803, the method 800 includes receiving via a graphical user interface a user input comprising a request associated with one or more parameters of a project. For example, the method 800 may include obtaining, at a project orchestration predictive computing entity 204, a user input. The user input may include natural language indicating the request and parameter of the project. For example, the user input may include natural language that comprises or embodies a request for a project design, a project proposal, one or more project resource impact values, one or more project requirements, and/or the like. In some embodiments, the request indicates multiple parameters or one or more portions of a particular parameter. For example, a first parameter may be a project design for a project, and a second parameter may be a project proposal. Further, a first portion of the project proposal may be associated with or comprise the project design, and a second portion of the project proposal may include or be associated with one or more project resource impact values.

In some embodiments, the method 800 may include performing one or more operations or sets of operations iteratively. For example, the method 800 may include receiving multiple user inputs from the same or different user devices 170, or from an external project application device 110, an external project implementation device 120, a project foundation device 180, and/or the like. As another example, the method 800 may include receiving a first user input from a user device 170, generating and provisioning to the user device 170 a first natural language output (e.g., including user-directed questions, confirmations, and/or the like), and receiving a second user input from the user device 170. In doing so, multiple parameters or portions of parameters of a project may be processed in parallel or sequentially. For example, a first data object may be generated in accordance with a first parameter of a project, and a second data object may be generated in accordance with a second parameter of a project and based at least in part on the first data object. In this manner, efficiency and accuracy of project quality validation processes may be improved by iteratively generating various portions of project proposal, project planning, and project implementation materials within a machine learning-based conversational framework.

In some embodiments, the method 800 includes generating a plurality of embeddings representing subsets of the user input. For example, the method 800 may include generating, using one or more machine learning models, a plurality of embeddings that represent respective subsets of the natural language of the user input. In some embodiments, the user input indicates data pursuant to the request. For example, the user input may include natural language configured to identify, provide, or direct an element of the cloud-based project operations device 140 to obtain and use as input one or more project documentation electronic records. In some embodiments, the method 800 includes generating a plurality of embeddings representing subsets of the data associated with the request. For example, the method 800 may include generating, via a machine learning model, a plurality of embeddings based at least in part on a project documentation electronic record. In some embodiments, the user input includes a modification to a data object, a dataset, and/or the like. In some embodiments, the method 800 includes generating, using a project prompt predictive computing entity 218, a plurality of embeddings based at least in part on the modification to enable machine learning models to generate new or updated data objects based thereon.

In some embodiments, at operation 806, the method 800 includes obtaining one or more datasets based at least in part on the user input. For example, the method 800 may include in response to receiving the user input, accessing, at a project orchestration predictive computing entity 204, one or more datasets based at least in part on the user input. In various embodiments, the dataset includes one or more project documentation electronic records, project resource data, historical data objects (e.g., historical project proposal electronic records), historical user inputs, and/or the like. In some embodiments, the method 800 includes obtaining, using the project orchestration predictive computing entity 204, the dataset based at least in part on one or more embeddings of the natural language of the user input, data associated with the request, and/or the like. For example, the method 800 may include accessing or generating, using the project orchestration predictive computing entity 204, the at least one dataset based at least in part on one or more embeddings representative of the user input, which may include natural language comprising or embodying instructions for generating a data object or modifying a data object previously obtained.

In some embodiments, the method 800 includes generating embeddings using a machine learning model. In some embodiments, the machine learning model includes one or more attention mechanisms (e.g., self-attention, scaled dot-product attention, multi-head attention, location-based attention, and/or the like). In various embodiments, the method 800 includes generating, via the attention mechanism, a plurality of attention weights associated with different subsets of user input, project documentation electronic records, and/or the like. In some embodiments, the method 800 includes generating a plurality of embeddings of a project documentation electronic record based at least in part on the user input the plurality of attention weights.

Additionally, or alternatively, in some embodiments, the method 800 includes generating one or more portions of the dataset based at least in part on other portions of the dataset, which may be accessed from a storage environment such as the database 150. For example, the method 800 may include accessing, at a project orchestration predictive computing entity 204, a project documentation electronic record, thereby defining a first portion of the dataset. The method 800 may further include determining, using a project extraction predictive computing entity 226, a plurality of project requirements from the project documentation electronic record. Additionally, the method 800 may include generating, using a project prompt predictive computing entity 218, one more embeddings based at least in part on the project documentation electronic record, one or more user inputs, one or more data objects, and/or the like, enabling the determination of the plurality of project requirements based at least in part on the plurality of embeddings.

In some embodiments, at operation 809, the method 800 includes generating a data object based at least in part on the user input and the dataset. For example, the method 800 may include generating, using a project record predictive computing entity 212, one or more data objects based at least in part on the user input and the dataset. In some embodiments, the data object includes one or more project design electronic records, resource impact value electronic records, project requirement electronic records, project proposal electronic records, and/or the like. In some embodiments, the method 800 includes generating a data object based at least in part on or in response to one or more additional data objects, user inputs, and/or the like. For example, the method 800 may include generating a project proposal electronic record based at least in part on one or more resource impact value electronic records, project design electronic records, and/or the like. As another example, in response to receiving approval of a project design electronic record, the method 800 may include generating a resource impact value electronic record. In some embodiments, the method 800 includes generating the data object using one or more machine learning models. For example, the method 800 may include generating the data object using one or more LLMs. In some embodiments, the method 800 includes modifying or regenerating a data object using the LLM and based at least in part on one or more user inputs, which may comprise natural language representing a desired adjustment or correction to the data object.

In some embodiments, at operation 812, the method 800 includes generating a natural language output based on the user input and the data object. For example, the method 800 may include generating, using the project orchestration predictive computing entity 204, a natural language output based at least in part on the user input, the data object, the dataset, and/or the like. In some embodiments, the natural language output comprises a description of the data object, such as a title of the data object, properties of the data object, and/or the like. In some embodiments, the natural language output includes one or more user-directed queries regarding aspects of the data object, such as whether to remove or include a subset of the data object or a manner of formatting the data object. In some embodiments, the method 800 includes generating the natural language output using one or more machine learning models, such as one or more LLMs. For example, the method 800 may include generating, using an LLM, a natural language output based at least in part on one or more user inputs, datasets, data objects, and/or the like. The data objects may include previously obtained data objects. For example, a natural language output that is associated with a resource impact value electronic record may be generated based at least in part on a project design electronic record.

In some embodiments, at operation 815, the method 800 includes rendering on the GUI of a user device 170 the natural language output and a media element, which may be based on the data object. For example, the method 800 may include causing rendering of the natural language output and a media element on the GUI. The media element may be representative of the data object. For example, the media element may be representative of project design electronic records, resource impact value electronic records, project proposal electronic records, project requirement electronic requirement records, and/or the like. In some embodiments, rendering the natural language output, the media element, and/or the like, includes serving an inline frame, page embedding, and/or the like to the user device 170. In various embodiments, the media element is dynamically rendered based at least in part on user inputs to the GUI, enabling a user entity to scroll, pane, zoom, or otherwise interface with and navigate the representation of the data object.

In some embodiments, at operation 818, the method 800 includes receiving via the GUI a second user input comprising an approval of the parameter of the project that is associated with the generated data object and natural language output. For example, the method 800 may include obtaining a second user input to the GUI rendered on the user device 170. The second user input may include natural language comprising or embodying an approval of the data object or one or more subsets of the data object. For example, the data object may include a plurality of project requirement electronic records indicative of a plurality of project requirements, and the second user input may include a modification to a first project requirement electronic record and an approval of a remaining subset of the plurality of project requirement electronic records. As another example, the second user input may include natural language indicating approval of all or a subset of a project design electronic record, resource impact value electronic record, project proposal electronic record, and/or the like.

Alternatively, or additionally, in some embodiments, the method 800 includes receiving a user input configured for modifying the data object. For example, the method 800 may include receiving from a user device 170 a user input comprising natural language for adjusting, removing, or expanding one or more portions of a data object. In various embodiments, the method 800 may proceed to operation 809 at which the data object may be modified, or a new data object generated, based at least in part on the user input. In some embodiments, the method 800 includes generating one or more embeddings based at least in part on the modification represented in the user input.

In various embodiments, a machine learning model configured for generating the data object and modifying the data object is trained based at least in part on the user input, the embedding of the modification, the previous data object, the modified or newly generated data object, and/or the like. For example, the method 800 may include training an instance of an LLM based at least in part on the modification represented in the user input, the embedding derived from the user input, the data object, and/or the like. In some embodiments, the method 800 includes storing the trained instance of the model in association with one or more unique identifiers for the user device 170, a user entity associated with the user device 170, a customer associated with the project, and/or the like. In this manner, multiple instances of an LLM may be iteratively trained to optimize or customize a respective model instance in accordance with objectives of a user entity, customer, and/or the like. For example, in generation of subsequent data objects, the method 800 may include determining an identifier associated with a requesting user entity, a customer of the project, and/or the like, and retrieving an instance of a trained LLM associated with the identifier. In doing so, the method 800 may generate project documentation materials that are more closely attuned to user and/or customer-specific preferences, which may further improve project quality.

In some embodiments, at operation 821, the method 800 includes updating a profile of the project based on the parameter and the data object, or a portion thereof. For example, the method 800 may include, in response to receiving a second user input to the GUI comprising an approval of the data object, updating, using the project record predictive computing entity 212, a profile associated with the project based at least in part on the parameter indicated in the user's request and the data object. In some embodiments, updating the profile includes provisioning (e.g., pushing, via one or more networks, application programming interfaces, and/or the like) an updated version of the profile, the data object, and/or the like to one or more systems, databases, devices, or other computing environments. For example, the method 800 may include pushing, via an updated profile of a project, a project proposal electronic record, and/or the like, to an external project application device 110, an external project implementation device 120, a project foundation device 180, and/or the like.

In some embodiments, the method 800 includes in response to receiving an approval of the project proposal electronic record, causing provision of the data object to one or more devices. For example, the method 800 may include, in response to receiving an approval of a project proposal electronic record, causing provision of the project proposal electronic record to a project foundation device 180, external project implementation device 120, external project application device 110, and/or the like. As another example, method 800 may include causing provision of one or more project requirement electronic records to an external project application device 110 to cause the external project application device 110 to store the project requirement electronic record. In some embodiments, the method 800 includes receiving user inputs, commands, and/or the like from devices to which data objects are transmitted and performing one or more actions based at least in part on the user inputs, commands, and/or the like. For example, the method 800 may include, in response to receiving from the project foundation device 180, an approval to perform the project in accordance with the project proposal electronic record, causing provision of the project proposal electronic record to one or more external project application devices 110, external project implementation devices 180, user devices 170, other project foundation devices 180, and/or the like.

In some embodiments, the method 800 includes, in response to receiving an authorization from a project foundation device 180 or user device 170, causing, using a project command predictive computing entity 116, performance of one or more project actions in accordance with the approved data object. For example, the method 800 may include, in response to receiving an authorization from a project foundation device 180, causing, using a project command predictive computing entity 116, performance of one or more project actions in accordance with a project proposal electronic record. In various embodiments, project actions include commanding user entities, computing entities, and/or the like to perform one or more tasks represented in the data object. For example, the method 800 may include generating a plurality of commands based at least in part on an authorized project proposal electronic record and provisioning the commands to one or more user devices 170 to cause the user devices 170 or associated user entities to perform one or more tasks. The command may include natural language outputs, data objects, and/or the like, that are comprised in or associated with the project proposal electronic record. For example, the command may include one or more project requirement electronic records, resource impact value electronic records, project design electronic records, and/or the like, which may increase task performance accuracy and, thereby, enhance project quality.

Operations and/or functions of the present disclosure have been described herein, such as in flowcharts. As will be appreciated, computer program instructions may be loaded onto a computer or other programmable apparatus (e.g., hardware) to produce a machine, such that the resulting computer or other programmable apparatus implements the operations and/or functions described in the flowchart blocks herein. These computer program instructions may also be stored in a computer-readable memory that may direct a computer, processor, or other programmable apparatus to operate and/or function in a particular manner, such that the instructions stored in the computer-readable memory produce an article of manufacture, the execution of which implements the operations and/or functions described in the flowchart blocks. The computer program instructions may also be loaded onto a computer, processor, or other programmable apparatus to cause a series of operations to be performed on the computer, processor, or other programmable apparatus to produce a computer-implemented process such that the instructions executed on the computer, processor, or other programmable apparatus provide operations for implementing the functions and/or operations specified in the flowchart blocks. The flowchart blocks support combinations of means for performing the specified operations and/or functions and combinations of operations and/or functions for performing the specified operations and/or functions. It will be understood that one or more blocks of the flowcharts, and combinations of blocks in the flowcharts, can be implemented by special purpose hardware-based computer systems which perform the specified operations and/or functions, or combinations of special purpose hardware with computer instructions.

While this specification contains many specific embodiments and implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

While operations and/or functions are illustrated in the drawings in a particular order, this should not be understood as requiring that such operations and/or functions be performed in the particular order shown or in sequential order, or that all illustrated operations be performed, to achieve desirable results. In certain circumstances, operations and/or functions in alternative ordering may be advantageous. In some cases, the actions recited in the claims may be performed in a different order and still achieve desirable results. Thus, while particular embodiments of the subject matter have been described, other embodiments are within the scope of the following claims.

Similarly, while operations are illustrated in the drawings in a particular order, this should not be understood as requiring that such operations be performed in the particular order shown or in sequential order, or that all illustrated operations be performed, to achieve desirable results. In certain circumstances, operations in alternative ordering may be advantageous. In some cases, the actions recited in the claims may be performed in a different order and still achieve desirable results.

1. A method comprising:
in response to receiving at least one user input to a graphical user interface (GUI) on a user device, accessing, at a project orchestration predictive computing entity, at least one dataset based at least in part on the at least one user input, wherein the at least one user input comprises natural language indicating a request associated with at least one parameter of a project;
generating, using a project record predictive computing entity, at least one data object based at least in part on the at least one user input and the at least one dataset;
generating, using the project orchestration predictive computing entity, at least one natural language output based at least in part on the at least one user input and the at least one data object;
causing rendering of the at least one natural language output and at least one media element on the GUI, wherein the at least one media element is representative of the at least one data object; and
in response to receiving a second user input to the GUI comprising an approval of at least a subset of the at least one data object, updating, using the project record predictive computing entity, at least one profile associated with the project based at least in part on the at least one parameter and the at least a subset of the at least one data object.

2. The method of claim 1, further comprising:
generating at least one embedding representative of the at least one user input; and
accessing, using the project orchestration predictive computing entity, the at least one dataset based at least in part on the at least one embedding.

3. The method of claim 1, wherein:
the at least one parameter of the project comprises a project design;
the at least one data object comprises a project design electronic record; and
the at least one media element comprises a representation of the project design electronic record.

4. The method of claim 3, wherein:
the at least one parameter of the project further comprises a project proposal;
a first portion of the project proposal is associated with the project design;
a second portion of the project proposal is associated with a project resource impact value; and
the method further comprises:
in response to receiving an approval of the project design electronic record generating, using the project record predictive computing entity and based at least in part on the at least one dataset, a resource impact value electronic record;
generating, using the project orchestration predictive computing entity, a second natural language output and a second media element based at least in part on the resource impact value electronic record; and
causing rendering of the second natural language output and the second media element on the GUI.

5. The method of claim 4, further comprising:
in response to receiving an approval of the resource impact value electronic record, generating, using the project record predictive computing entity, a project proposal electronic record based at least in part on the resource impact value electronic record and the project design electronic record.

6. The method of claim 5, further comprising:
generating, using the project orchestration predictive computing entity, a third natural language output and a third media element based at least in part on the project proposal electronic record;
causing rendering of the third natural language output and the third media element on the GUI; and
in response to receiving an approval of the project proposal electronic record, causing provision of the project proposal electronic record to a project foundation device.

7. The method of claim 6, further comprising:
in response to receiving from the project foundation device, an approval to perform the project in accordance with the project proposal electronic record, causing provision of the project proposal electronic record to at least one of an external project application device or an external project implementation device.

8. The method of claim 6, further comprising:
in response to receiving an authorization from the project foundation device, causing, using a project command predictive computing entity, performance of at least one project action in accordance with the project proposal electronic record.

9. The method of claim 1, further comprising:
generating the at least one data object using at least one large language model (LLM).

10. The method of claim 9, further comprising:
generating the at least one natural language output using the at least one LLM.

11. The method of claim 9, further comprising:
in response to receiving a user input comprising at least one modification to the at least one data object, generating, using a project prompt predictive computing entity, at least one embedding representative of the at least one modification; and
modifying, using the project record predictive computing entity, the at least one data object based at least in part on the at least one embedding.

12. The method of claim 11, further comprising:
training, using the project record predictive computing entity, an instance of the at least one LLM based at least in part on at least one of the at least one modification, the at least one embedding, or the at least one data object.

13. The method of claim 12, further comprising:
obtaining, at the project orchestration predictive computing entity, at least one identifier associated with at least one of the user device or a user entity associated with the user device; and
storing, at a data store, the instance of the at least one LLM in association with the at least one identifier.

14. An apparatus comprising memory and one or more processors communicatively coupled to the memory, the one or more processors configured to perform operations comprising:
in response to receiving at least one user input to a graphical user interface (GUI) on a user device, accessing, at a project orchestration predictive computing entity, at least one dataset based at least in part on the at least one user input, wherein the at least one user input comprises natural language indicating a request associated with at least one parameter of a project;
generating, using project record predictive computing entity, at least one data object based at least in part on the at least one user input and the at least one dataset;
generating, using the project orchestration predictive computing entity, at least one natural language output based at least in part on the at least one user input and the at least one data object;
causing rendering of the at least one natural language output and at least one media element on the GUI, wherein the at least one media element is representative of the at least one data object; and
in response to receiving a second user input to the GUI comprising an approval of at least a subset of the at least one data object, updating, using the project record predictive computing entity, at least one profile associated with the project based at least in part on the at least one parameter and the at least a subset of the at least one data object.

15. The apparatus of claim 14, wherein:
the at least one parameter comprises project requirements;
the at least one dataset comprises at least one project documentation electronic record;
the one or more processors are further configured to perform operations comprising:
determining, using a project extraction predictive computing entity, a plurality of project requirements from the at least one project documentation electronic record; and
generating, using the project record predictive computing entity, a plurality of project requirement electronic records representative of the plurality of project requirements;
the at least one data object comprises at least a subset of the plurality of project requirement electronic records; and
the at least one media element is representative of the at least a subset of the plurality of project requirement electronic records.

16. The apparatus of claim 15, wherein:
the one or more processors are further configured to perform operations comprising:
generating a plurality of embeddings based at least in part on the at least one project documentation electronic record; and
determining the plurality of project requirements based at least in part on the plurality of embeddings.

17. The apparatus of claim 16, wherein:
the one or more processors are further configured to perform operations comprising:
generating, via at least one attention mechanism of a machine learning model, a plurality of attention weights associated with different subsets of the at least one user input; and
generating, via the at least one machine learning model, the plurality of embeddings based at least in part on the at least one user input and the plurality of attentions weights.

18. The apparatus of claim 17, wherein:
the at least one attention mechanism is at least one of self-attention, scaled dot-product attention, multi-head attention, or location-based attention.

19. The apparatus of claim 15, wherein:
the one or more processors are further configured to perform operations comprising:
causing provision of the at least a subset of project requirement electronic records to at least one external project application device to cause the at least one external project application device to store the at least a subset of the plurality of project requirement electronic records.

20. A computer program product comprising at least one non-transitory computer-readable storage medium having computer program code stored thereon that, in execution with at least one processor, configures the computer program product for:
in response to receiving at least one user input to a graphical user interface (GUI) on a user device, accessing, at a project orchestration predictive computing entity, at least one dataset based at least in part on the at least one user input, wherein the at least one user input comprises natural language indicating a request associated with at least one parameter of a project;
generating, using project record predictive computing entity, at least one data object based at least in part on the at least one user input and the at least one dataset;
generating, using the project orchestration predictive computing entity, at least one natural language output based at least in part on the at least one user input and the at least one data object;
causing rendering of the at least one natural language output and at least one media element on the GUI, wherein the at least one media element is representative of the at least one data object; and
in response to receiving a second user input to the GUI comprising an approval of at least a subset of the at least one data object, updating, using the project record predictive computing entity, at least one profile associated with the project based at least in part on the at least one parameter and the at least a subset of the at least one data object.
